(19) United States
(12) Patent Application Publication
(10) Pub. No.: US 2020/0090050 A1
(43) Pub. Date: Mar. 19, 2020

(54) SYSTEMS AND METHODS FOR TRAINING GENERATIVE MACHINE LEARNING MODELS WITH SPARSE LATENT SPACES

(71) Applicant: D-WAVE SYSTEMS INC., Burnaby (CA)

(72) Inventors: Jason T. Rolfe, Vancouver (CA); Seyed Ali Saberali, Vancouver (CA); William G. Macready, West Vancouver (CA)

(21) Appl. No.: 16/562,192

(22) Filed: Sep. 5, 2019

Related U.S. Application Data
(60) Provisional application No. 62/731,694, filed on Sep. 14, 2018.

(51) Int. Cl. G06N 3/08; G06N 3/04

(52) U.S. Cl. CPC G06N 3/088; G06N 3/0445

(57) ABSTRACT

Generative machine learning models, such as variational autoencoders, with comparatively sparse latent spaces are provided. Continuous latent variables are activated and/or inactivated based on a state of the latent space. Activation may be controlled by corresponding binary latent variables and/or by rectification of probability distributions defined over the latent space. Sparsification may be supported by normalization of terms, such as providing an L1 or L2 prior.

### FIELD

This disclosure generally relates to machine learning, and particularly to training generative machine learning models.

### BACKGROUND

Machine learning relates to methods and circuitry that can learn from data and make predictions based on data. In contrast to methods or circuitry that follow static program instructions, machine learning methods and circuitry can include deriving a model from example inputs (such as a training set) and then making data-driven predictions.

Machine learning is related to optimization. Some problems can be expressed in terms of minimizing a loss function on a training set, where the loss function describes the disparity between the predictions of the model being trained and observable data.

Machine learning methods are generally divided into two phases: training and inference. One common way of training certain machine learning models involves attempting to minimize a loss function over a training set of data. The loss function describes the disparity between the predictions of the model being trained and observable data. There is tremendous variety in the possible selection of loss functions, as they need not be exact they may, for example, provide a lower bound on the disparity between prediction and observed data, which may be characterized in an infinite number of ways.

The loss function is, in most cases, intractable by definition. Accordingly, training is often the most computationally-demanding aspect of most machine learning methods, sometimes requiring days, weeks, or longer to complete even for only moderately-complex models. There is thus a desire to identify loss functions for a particular machine learning model which are less resource-intensive to compute. However, loss functions which impose looser constraints on the trained model's predictions tend to result in less-accurate models. The skilled practitioner therefore has a difficult problem to solve: identifying a low-cost, high-accuracy loss function for a particular machine learning model.

A variety of training techniques are known for certain machine learning models using continuous latent variables, but these are not easily extended to problems that require training latent models with discrete variables, such as embodiments of semi-supervised learning, binary latent attribute models, topic modeling, variational memory addressing, clustering, and/or discrete variational autoencoders. To date, techniques for training discrete latent variable models have generally been computationally expensive relative to known techniques for training continuous latent variable models (e.g., as is the case for training discrete variational autoencoders, as described in PCT application no. US2016/047627) and/or have been limited to specific architectures (e.g. by requiring categorical distributions, as in the case of Eric Jang, Shixiang Gu, and Ben Poole, Categorical reparameterization with gumbel-softmax, arXiv preprint arXiv:1611.01144, 2016).

There is thus a general desire for systems and methods for training latent machine learning models with discrete variables having general applicability, high efficiency, and/or high accuracy.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Aspects of the present disclosure provide systems and methods for unsupervised learning over an input space comprising a plurality of input variables, and at least a subset of a training dataset of samples of the respective variables, to attempt to identify the value of at least one parameter that increases the log-likelihood of the at least a subset of a training dataset with respect to a model. The model is expressible as a function of the at least one parameter. The method is executed by circuitry including at least one processor and comprises forming a latent space comprising a plurality of continuous random latent variables and forming an approximating posterior distribution over the latent space, conditioned on the input space. The approximating posterior is formed by, for each of the continuous random latent variables, truncating a corresponding encoding base distribution based on input data from the input space. The method further comprises forming a prior distribution over the latent space, forming a decoding distribution over the input space, and training the model based on the encoding, prior, and decoding distributions.

In some implementations, forming the prior distribution comprises, for each of the continuous random latent variables, truncating a corresponding prior base distribution by rectifying the corresponding prior base distribution based on the continuous random latent variable.

In some implementations, for each continuous random latent variable, the corresponding encoding base distribution and the corresponding prior base distribution are parametrizations of a shared distribution, forming the prior distribution comprises truncating the shared distribution, and forming the approximating posterior distribution comprises truncating the shared distribution.

In some implementations, the shared distribution comprises a Gaussian distribution and truncating the shared distribution comprises truncating the Gaussian distribution.

In some implementations, when forming the approximating posterior, truncating the corresponding encoding base distribution comprises rectifying at least one of the continuous random latent variables.

In some implementations, training the model comprises determining a gradient over the approximating posterior based on a reparametrization of the at least one of the continuous random latent variables.

In some implementations, rectifying at least one of the continuous random latent variables comprises applying a rectified linear unit to an initial value of the at least one of the continuous random latent variables generated by the approximating posterior distribution.

In some implementations, forming the latent space further comprises forming a plurality of discrete random latent variables and, for each of the plurality of continuous variables, truncating the corresponding prior base distribution comprises truncating the corresponding prior base distribution based on a state of a corresponding one of the discrete random latent variables.

In some implementations, for each of the plurality of continuous variables, truncating the corresponding prior base distribution based on the state of the corresponding one of the discrete random latent variables comprises selecting at least one of: an activation regime and an inactivation regime. If the activation regime is selected, the method involves causing samples to be drawn for the continuous random variable from the corresponding prior base distribution. If the inactivation regime is selected, the method involves causing samples to be drawn for the continuous random variable from a singularity distribution.

In some implementations, the singularity distribution comprises a Dirac delta distribution.

In some implementations, training the model comprises regularizing one or more continuous random latent variables based on the one or more continuous random latent variables being in the activation regime.

In some implementations, each of a first subset of the plurality of continuous random latent variables share a first common base distribution and forming the approximating posterior distribution comprises, for each of the first subset, truncating a corresponding approximating posterior base distribution comprises truncating the first common base distribution.

In some implementations, training the model comprises determining a gradient of an objective function based on a reparametrization of the first subset of continuous random latent variables.

In some implementations, each of a second subset of the plurality of continuous random latent variables share a second common base distribution. The second common base distribution has at least one trainable parameter separate from the one or more trainable parameters of the first common base distribution. Forming the approximating posterior distribution comprises, for each continuous random latent variable of the second subset, truncating a corresponding approximating posterior base distribution comprises truncating the first common base distribution.

Aspects of the present disclosure provide systems and methods for unsupervised learning over an input space comprising discrete or continuous variables, and at least a subset of a training dataset of samples of the respective variables, to attempt to identify the value of at least one parameter that increases the log-likelihood of the at least a subset of a training dataset with respect to a model. The model is expressible as a function of the at least one parameter and is executed by circuitry including at least one processor. The method comprises forming a latent space comprising a plurality of random variables, the plurality of random variables comprising one or more selectively-activatable continuous random variables and one or more binary random variables. Each binary random variable corresponds to a subset of the one or more selectable continuous random variables. Each binary random variable has on and off states. The method further comprises training the model by setting each of the one or more binary random variables to a respective ON state, determining a first updated set of the one or more parameters of the model based on each of the one or more selectively-activatable continuous random variables being active, updating the one or more parameters of the model based on the first updated set of the one or more parameters, said updating comprising setting at least one of the one or more binary random variables to a respective OFF state based on the first updated set of the one or more parameters, determining a second updated set of the one or more parameters of the model based on one or more selectively-activatable continuous random variables which correspond to binary random variables in respective ON states, said determining comprising deactivating one or more continuous random variables which correspond to binary random variables in respective OFF states, and updating the one or more parameters of the model based on the second updated set of the one or more parameters.

In some implementations, forming the latent space comprises forming a Boltzmann machine, the Boltzmann machine comprising the one or more binary random variables, and wherein training the model comprises training the Boltzmann machine.

In some implementations, training the model comprises transforming at least one of the one or more binary random variables according to a smoothing transformation and determining at least one of the first and second updated sets of the one or more parameters based on the smoothing transformation.

In some implementations, transforming at least one of the one or more binary random variables comprises transforming the at least one of the one or more binary random variables according to a spike-and-exponential transformation comprising a spike distribution and an exponential distribution.

In some implementations, the training the model comprises determining an objective function comprising a penalty based on a difference between a mean of the spike distribution and a mean of the exponential distribution.

In some implementations, determining the first updated set of parameters comprises determining the first updated set of parameters based on an approximating posterior distribution where the spike distribution is given no effect.

In some implementations, determining the first updated set of parameters comprises determining the first updated set of parameters based on a prior distribution where the spike distribution and exponential distribution have the same mean.

In some implementations, the latent space comprises one or more smoothing continuous random variables defined over the binary random variables and training the model comprises predicting each binary random variable from a corresponding one of the smoothing continuous random variables.

In some implementations, training the model comprises training at least one of an approximating posterior distribution and prior distribution based on a spectrum of exponential distributions, the spectrum of exponential distributions being a function of at least one of the smoothing continuous random variables and converging to a spike distribution for a first state of the at least one of the smoothing continuous random variables.

In some implementations, training the model comprises training an L1 prior distribution. In some implementations, training an L1 prior comprises training a Laplace distribution.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of an exemplary hybrid computer including a digital computer and an analog computer in accordance with the present systems, devices, methods, and articles.

FIG. 2 is a flowchart of an example method for training an example VAE to induce sparsity with binary variables.

FIG. 3 is a flowchart of an example method for training an example rectifying VAE.

### DETAILED DESCRIPTION

The present disclosure provides novel architectures for machine learning models having sparse latent variables, and particularly to systems instantiating such architectures and methods for training and inference therewith. Continuous latent variables of the machine learning model are activated and/or inactivated based on a state of the latent space. This may be accomplished by, for example, activating continuous latent variables based one the state of corresponding binary latent variables, by rectification of probability distributions defined over the latent space, and/or by normalization of terms (e.g. by providing an L1 or L2 prior).

### Introductory Generalities

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

### Computing Systems

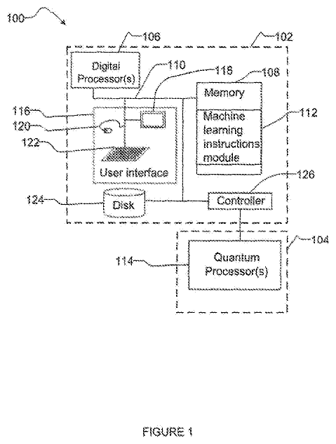

FIG. 1 illustrates a computing system 100 comprising a digital computer 102. The example digital computer 102 includes one or more digital processors 106 that may be used to perform classical digital processing tasks. Digital computer 102 may further include at least one system memory 108, and at least one system bus 110 that couples various system components, including system memory 108 to digital processor(s) 106. System memory 108 may store a VAE instructions module 112.

The digital processor(s) 106 may be any logic processing unit or circuitry (e.g., integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an analog computer 104, which may include one or more quantum processors 114. Digital computer 102 may communicate with analog computer 104 via, for instance, a controller 126. Certain computations may be performed by analog computer 104 at the instruction of digital computer 102, as described in greater detail herein.

Digital computer 102 may include a user input/output subsystem 116. In some implementations, the user input/output subsystem includes one or more user input/output components such as a display 118, mouse 120, and/or keyboard 122.

System bus 110 can employ any known bus structures or architectures, including a memory bus with a memory controller, a peripheral bus, and a local bus. System memory 108 may include non-volatile memory, such as read-only memory (“ROM”), static random access memory (“SRAM”), Flash NAND; and volatile memory such as random access memory (“RAM”) (not shown).

Digital computer 102 may also include other non-transitory computer- or processor-readable storage media or non-volatile memory 124. Non-volatile memory 124 may take a variety of forms, including: a hard disk drive for reading from and writing to a hard disk (e.g., magnetic disk), an optical disk drive for reading from and writing to removable optical disks, and/or a solid state drive (SSD) for reading from and writing to solid state media (e.g., NAND-based Flash memory). The optical disk can be a CD-ROM or DVD, while the magnetic disk can be a rigid spinning magnetic disk or a magnetic floppy disk or diskette. Non-volatile memory 124 may communicate with digital processor(s) via system bus 110 and may include appropriate interfaces or controllers 126 coupled to system bus 110. Non-volatile memory 124 may serve as long-term storage for processor- or computer-readable instructions, data structures, or other data (sometimes called program modules) for digital computer 102.

Although digital computer 102 has been described as employing hard disks, optical disks and/or solid state storage media, those skilled in the relevant art will appreciate that other types of nontransitory and non-volatile computer-readable media may be employed, such magnetic cassettes, flash memory cards, Flash, ROMs, smart cards, etc. Those skilled in the relevant art will appreciate that some computer architectures employ nontransitory volatile memory and nontransitory non-volatile memory. For example, data in volatile memory can be cached to non-volatile memory. Or a solid-state disk that employs integrated circuits to provide non-volatile memory.

Various processor- or computer-readable instructions, data structures, or other data can be stored in system memory 108. For example, system memory 108 may store instruction for communicating with remote clients and scheduling use of resources including resources on the digital computer 102 and analog computer 104. Also for example, system memory 108 may store at least one of processor executable instructions or data that, when executed by at least one processor, causes the at least one processor to execute the various algorithms described elsewhere herein, including machine learning related algorithms. For instance, system memory 108 may store a machine learning instructions module 112 that includes processor- or computer-readable instructions to provide a machine learning model, such as a variational autoencoder. Such provision may comprise training and/or performing inference with the machine learning model, e.g., as described in greater detail herein.

In some implementations system memory 108 may store processor- or computer-readable calculation instructions and/or data to perform pre-processing, co-processing, and post-processing to analog computer 104. System memory 108 may store a set of analog computer interface instructions to interact with analog computer 104. When executed, the stored instructions and/or data cause the system to operate as a special purpose machine.

Analog computer 104 may include at least one analog processor such as quantum processor 114. Analog computer 104 can be provided in an isolated environment, for example, in an isolated environment that shields the internal elements of the quantum computer from heat, magnetic field, and other external noise (not shown). The isolated environment may include a refrigerator, for instance a dilution refrigerator, operable to cryogenically cool the analog processor, for example to temperature below approximately 1° Kelvin.

### Variational Autoencoders

The present disclosure has applications in a variety of machine learning models. As an example, we will refer frequently to variational autoencoders (“VAEs”), and particularly to discrete variational autoencoders (“DVAEs”). A brief review of DVAEs is provided below; a more extensive description can be found in PCT application no. US2016/047627.

A VAE is a generative model that defines a joint distribution over a set of observed random variables x and a set of latent variables z. The generative model may be defined by p(x,z)=p(z)·p(x|z) where p(z) is a prior distribution and p(x|z) is a probabilistic decoder. Given a dataset X={x⁽¹⁾, . . . , x^{N}}, the parameters of the model may be trained by maximizing the log-likelihood:

$$log p ( X ) = {\sum }_{i = 1}^{N} log p ( {x}^{( i )} ) .$$

Typically, computing log p(x) requires an intractable marginalization over the latent variables z. To address this problem, a VAE introduces an inference model or probabilistic encoder q(z|x) that infers latent variables for each observed instance. q(z|x) is an approximation of the true posterior distribution over the latent representation and so is often referred to as the approximating posterior distribution (or simply the approximating posterior). Typically, instead of maximizing the marginal log-likelihood, a VAE will maximize a variational lower bound (also called an evidence lower bound, or ELBO), usually in the following general form:

log p(x)≥ [symbol] _{q(Z|X)}[log p(x|z)]−KL[q(z|x)∥p(z)]

where the KL term is the Kullback-Leibler divergence.

The gradient of this objective may be computed for the parameters of both the encoder and decoder using a technique referred to as “reparameterization” (and sometimes as the “reparametrization trick”). With reparametrization, the expectation with respect to q(z|x) in the ELBO is replaced with an expectation with respect to a known optimization-parameter-independent base distribution and a differentiable transformation from the base distribution to q(z|x). For instance, in the case of a Gaussian base distribution, the transformation may be a scale-shift transformation. As another example, the transformation may rely on the inverse cumulative distribution function (CDF). During training, the gradient of the ELBO is estimated using samples from the base distribution.

This training process is challenging to apply to discrete VAEs, as there is no known differentiable transformation that maps a base distribution to a suitable discrete distribution. This may be addressed by, for example, applying the various systems and method described in PCT application no. US2016/047627, which describes a hiding approach where a binary random variable z with probability mass function q(z|x) is transformed using a spike-and-exponential transformation r(ζ|z) where r(ζ|z=0)=δ(ζ) is a Dirac delta distribution (i.e. the “spike”) and r(ζ|z=1)∝exp(βζ) is an exponential distribution defined for ζϵ[0,1] with inverse temperature β controlling the sharpness of the distribution. The marginal distribution q(ζ|x) is a mixture of two continuous distributions. By factoring the inference model of the DVAE so that x depends on ζ rather than z, the discrete variables can be eliminated from the ELBO (effectively “hidden” behind continuous variables ζ) and reparametrization can be applied. U.S. provisional patent application No. 62/673,013 provides further approaches.

VAEs have a tendency to generate dense latent representations. Even if a VAE has hundreds of latent variables available to it, in many instances only a handful (e.g. concentrated largely in the first layer of the VAE's encoder) are actively used by the approximating posterior. For example, in at least one experiment involving a VAE trained to perform collaborative filtering (e.g. as described by Rolfe, Discrete Variational Autoencoder, arXiv preprint arXiv:1609.02200 (2016), incorporated herein by reference) on a database of millions of user ratings (with tens of thousands of both users and items), the VAE tended to use fewer than 40 continuous latent variables regardless of the number of latent variables available to it or the size of the training set. Similar experiments with the widely-available MNIST dataset tend to use about 20 active latent variables regardless of the total number of latent variables available. Unused variables tend to remain roughly identical to the prior.

There are competing objectives in the design of a VAE. For instance, providing more active latent variables tends to increase the representational power of the model, but making representations less dense so that representational information is spread across a larger number of variables will tend to induce a significant cost in training. For instance, where the VAE's objective function is formulated as a difference between a KL term and a log-likelihood, the magnitude of the KL term tends to grow quickly as additional active variables are introduced.

In some implementations, a VAE is provided with one or more selectively-activatable latent variables. The activation of selectively-activatable latent variables can itself be trained, thereby allowing latent variables which are unused for certain inputs to be deactivated (or “turned off”) when appropriate and re-activated when appropriate. This is expected, in suitable circumstances, to tend to reduce the cost of temporarily-deactivated latent variables during training, thereby reducing the incentive to make the latent representation more dense. This can lead, in at least some cases, to greater sparsity and/or multimodality.

### Variance-Sparsifying VAEs

For example, the VAE may comprise a DVAE with a plurality of binary latent variables. Each binary latent variable (call it z) may be associated with one or more continuous latent variables (call it/them ζ), each of which is selectively-activatable. (There may, optionally, be further binary and/or continuous latent variables in the DVAE which are not necessarily related in this way.) The binary latent variables induce activation or deactivation of their associated continuous latent variables based on their state (e.g. an on state and an off state). Where the binary latent variables are elements of a trainable structure, such as a Boltzmann machine (classical and/or quantum, e.g. an RBM and/or QBM), this activation or deactivation can itself be trained.

A challenge that can arise is that the transition induced by the binary latent variables (from active to inactive) can be discontinuous, in which case the binary latent variables will not be easily trainable by gradient descent. This can be mitigated by transforming the binary latent variable to limit and/or avoid discontinuities during training (and, optionally, during inference). Some non-limiting examples of such transformations follow.

For instance, in at least some implementations where the latent binary variables are transformed according to a spike-and-exponential transformation (e.g. as described in PCT application no. US2016/047627) where the spike corresponds to the inactive state, large discontinuities may be at least partially avoided by locating the spike portion of the transformation (i.e. the Dirac delta distribution) at a point other than z=0. For example, the spike portion of the transformation can be defined according to r(ζ|z= [symbol] [p(x|z)])=δ(ζ); that is, the spike for a given variable can be located at the mean of the prior distribution for that variable (e.g. determined based on the earlier layers of the VAE the location of the spike may be predetermined for the first layer, e.g. at 0).

A potential advantage of such an approach is that discretely flipping to the mean of the prior distribution will tend not to strongly disrupt reconstruction where the approximating posterior and prior are similar. It also reduces the variance of the binary latent variable to 0 when in the off state, meaning that the contribution of the associated continuous latent variable(s) to the reconstruction term can be limited when the binary latent variable is in the off state without explicitly disconnecting the continuous latent variable(s) from the decoder.

In some implementations, such a spike-and-exponential-based DVAE is trained according to a warm-up procedure wherein, during one or more initial phases of warmup, all binary latent variables are active. As training progresses to later phases, one or more (and perhaps even most) of the binary latent variables are inactive when training on each element of the dataset the set of active binary latent variables may vary from element to element. The continuous latent variables associated with the inactive binary latent variables are removed either implicitly (e.g. by setting them to a default value, such as 0 or the mean of the continuous latent variable's prior distribution) or explicitly (e.g. by not processing the deactivated continuous latent variables in the decoder based on a logical switch).

The set of active (continuous) latent variables for a given input element may, in suitable circumstances, tend to specify a category. For example, each latent variable may correspond to a feature or component in the input space. For instance, a set of active latent variables which includes a latent variable that corresponds to cat ears, another latent variable that corresponds to furry legs, and yet another latent variable that corresponds to whiskers might suggest that the category “cat” is applicable to the given input element.

This does not mean that the value of each latent variable is irrelevant. In effect, each set of variables defines a region of the latent space within which inference may occur. For instance, in an example where p(x|z) is a multivariate Gaussian over d dimensions, one can expect the probability mass of the distribution to be largely concentrated in a shell distance σ·\sqrt{d} with thickness O(σ). One can therefore expect selecting a subset of active latent variables to define a latent subspace with probability mass largely bounded away from the origin and disjoint from subspaces associated with other disjoint subsets of active latent variables. The values of the active continuous latent variables identify a point or region in the relevant latent subspace. Alternatively presented, the set of active latent variables can be thought of as identifying a set of filters to apply to the input, and the operation of each filter is dependent on the value of the corresponding active latent variable(s). This effectively separates the modes of the prior and/or approximating posterior distributions, thereby promoting sparsity.

In some implementations, the modes of the prior distribution are rebalanced even after being separated. For example, a discrete-valued prior may be used, thereby allowing rebalancing through shifting probability between discrete points without having to “jump” across low-probability regions of the latent space.

In some implementations, the approximating posterior is defined (at least in part) as an offset on the prior distribution. This binds the two distributions together. The spike (in a spike-and-exponential embodiment) may be held close to the mean of the exponential distribution by applying a penalty based on a distance between the spike and the mean of the exponential distribution. The penalty may comprise, for example, an L2 loss and/or a measure of the probability of the spike location according to the exponential distribution (which, at least for a Gaussian distribution, is equivalent to an L2 loss with length scaled proportionately to the variance of the Gaussian distribution.) Alternatively, or additionally, the location of the exponential distribution may be parametrized so that the Gaussian is moved relative to the spike during training.

In some such implementations, during early phases of training the spikes are not used by the approximating posterior and, in the prior, the spikes are held at the mean of the exponential distribution. Later in training (i.e. after one or more iterations of the early phase), the spikes are used by the approximating posterior and can be pulled away from the mean of the exponential distribution.

In some implementations, the VAE is a convolutional VAE, where each latent variable is expandable into a feature map with a plurality (e.g. hundreds) of variables. By actively selecting a subset of latent variables for each element of the dataset (e.g. by selecting the variables with best fit for the element e.g. those with highest probability) and turning off the rest, the number of variables which may be used by the model to store representational information may, in suitable circumstances, be increased relative to a conventional convolutional VAE.

The foregoing examples wherein continuous latent variables are activated based on the state of a binary latent variable are not exhaustive. In some implementations, the activatable continuous latent variables are activated (or deactivated) based on the state of one or more continuous latent variables. This has the potential to better represent multimodality in the approximating posterior (which is typically highly multimodal).

For example, in some implementations continuous smoothing latent variables s are defined over the set of binary latent variables such that each smoothing latent variable is associated with a corresponding binary latent variable. Smoothing latent variables may be defined over the interval [0,1], [symbol] , or any other suitable domain. Rather than (or in addition to) predicting the smoothed latent variables ζ from the binary latent variables z, the computing system predicts the binary latent variables z from the smoothed latent variables s. This allows the latent representation to change continuously, subject to the regularization of the binary latent variables z. The smoothed latent variables s may thus exhibit (for example) RBM-structured bimodality over the entire dataset.

In such an implementation, the approximating posterior and model distributions may be defined as:

q(z,s,ζ|x)=q(s|x)·q(z|s,x)·q(ζ|s,x)

p(x,s,z,ζ)=p(z)·p(s|z)·p(ζ|s)·p(x|ζ)

where q(s|x)=δ_{ƒ(x)}, i.e. the Dirac delta function centered at ƒ(x), where ƒ(x) is some deterministic function of x. Although this formulation of the smoothing variables s does not does not capture the uncertainty of the approximating posterior (or, indeed, much information at all), it can help to ensure that the autoencoding loop is not subject to excessive noise and allows for convenient analytical calculation. The q(s|x) term (a form of the approximating posterior) may be distributed to concentrate most of its probability near to the extremes of its domain, uniformly over its domain, and/or as otherwise selected by a user. Distributions which largely concentrate probability near to the values corresponding to the binary modes of the underlying binary latent variables z (as opposed to the intervening range) are likely to be the most broadly useful forms.

In some implementations, the approximating posterior and prior distributions are spectrums of Gaussian distributions, dependent on the smoothing latent variables s. When s=1, the approximating posterior may be a Gaussian dependent on the input, and the prior should be a Gaussian independent of the input. When s=0, both the approximating posterior and the prior may converge to a common Dirac delta spike independent of the input. In such an implementation, decreasing s will tend to decrease the uncertainty (e.g. the variance) and the dependence on the input of the approximating posterior, whereas for the prior only the uncertainty is decreased.

For example, the approximating posterior and prior distributions can be defined over ζ as follows:

qₛ(ζ|s,x)= [symbol] (s·μ_{q}+(1−s)·μₚ,s·σ_{q}²)

pₛ(ζ|s)= [symbol] (μp,s,·σₚ²)

where μ_{g} and σ_{q} are functions of x (and optionally, hierarchically previous ζ) and μₚ and σₚ are not necessarily functions of x (and, optionally, are also functions of hierarchically previous ζ) These are Gaussian distributions, and so the KL term between them can be expressed as a sum of two terms, as follows:

$$KL ( {q}_{s} \vert \vert {p}_{s} ) = s \cdot \frac{{( {μ}_{q} - {μ}_{p} )}^{2}}{2 {σ}_{p}^{2}} + \frac{1}{2} ( \frac{{σ}_{q}^{2}}{{σ}_{p}^{2}} - 1 - log \frac{{σ}_{q}^{2}}{{σ}_{p}^{2}} ) .$$

The second term will be minimized when σₚ²=σ_{q}² and the first term will be minimized when s=0 or μ_{q}=μₚ. In this formulation, both qₛ and pₛ converge to a delta spike at μₚ as s→0. As a result, s governs the trade-off between the original input-dependent Gaussian approximating posterior and an input-independent noise-free distribution.

As another example, we can define the approximating posterior and prior distributions over as follows:

qₛ(ζ|s,x)= [symbol] (s·μ_{g}+(1−s)·μₚ,s²·σ_{q}²+(1−s)·s·σₚ²)

pₛ(ζ|s)= [symbol] (μₚ,s·σₚ²)

then the optimum remains at σ_{q}→σₚ as s→0, and the a-dependent component of the KL term decays as s→0. So long as the standard deviation of qₛ decays slower than its mean, the accuracy of the approximating posterior will generally stay roughly constant or even tend to increase as s decreases.

Further alternative (or additional) forms of qₛ and pₛ are possible; for example, one can define the mean of qₛ to be μ_{q}=s²·μ_{q}+(1−s²)·μₚ.

The binary latent variables z may be used to govern the prior distribution over s, which can assist with the representation of multimodal distributions. For example, the prior can over s can be defined as:

p(s|z=0)=2·(1−s)

p(s|z=1)=2·s

or as:

$$p ( s \vert z = 0 ) = β \frac{{e}^{β ( 1 - s )}}{{e}^{β} - 1}$$

$$p ( s \vert z = 1 ) = β \frac{{e}^{β s}}{{e}^{β} - 1} .$$

In either case, the prior can be defined as an a Boltzmann machine (such as an RBM) and/or a quantum Boltzmann machine (such as a QBM) over z. In the limit as β→∞, s will tend to converge to binary values corresponding to those of the underlying binary latent variables z and the distributions tend to converge to distributions similar to those of the unsmoothed variance-sparsifying VAE implementations described above.

The KL-divergence of such an implementation can be given by:

$$KL [ q ( z , s , ζ \vert x ) \vert \vert p ( z , s , ζ ) ] = {𝔼}_{q ( S , X ) \cdot q ( Z \vert S , X ) \cdot q ( ζ \vert s , x )} [ log \frac{q ( s \vert x ) \cdot q ( z \vert s , x ) \cdot q ( ζ \vert s , x )}{p ( z ) \cdot p ( s \vert z ) \cdot p ( ζ \vert s )} ] .$$

The values of binary latent variables do not necessarily unambiguously determine the values of the continuous latent variables in this formulation. If the spikes in the approximating posterior and prior distributions for a given smoothing continuous latent variable sᵢ do not align, then they do not interact. That is, if q(sᵢ|x)=δ_{σ}(sᵢ) and p(sᵢ|zᵢ=0)=δᵥ(sᵢ) then

$$\frac{\partial }{\partial {s}_{i}} p ( {s}_{i} \vert {z}_{i} = 0 ) = 0$$

if σ≠v.

This can pose obstacles to applying the training approach based on the cross-entropy term [symbol] _{q} [Wᵢⱼ·zᵢ·zⱼ] presented in the aforementioned paper. However, the presently-described method enables a simpler and (in at least some circumstances) lower-variance approach. In implementations where q(z|x,s,ζ)=Πᵢq(zᵢ|x,x,ζ), a the cross-entropy term can be reformulated as:

[symbol]

_{q}[Wᵢⱼ·zᵢ·zⱼ]=Wᵢⱼ· [symbol] _{q}[q(zᵢ=1|ζ_{k<i},x)·q(zⱼ=1|ζ_{k<j},x)].

In some implementations, the foregoing sparsification techniques are complemented by providing an L1 prior, which induces sparsity (including in the hidden layers of the VAE). In some implementations this involves determining the KL term via sampling-based estimates rather than (or in addition to) analytic processes. The hidden layers of the approximating posterior and the prior distributions over binary latent variables (i.e. q(zᵢ|x, z_{j<i}) and p(zᵢ|z_{j<i}), respectively) may comprise deterministic hidden layers to assist in inducing sparsity. In at least some implementations, the means of the approximating posterior and prior distributions over the binary latent variables contract to a delta spike at the mean of the prior.

In some implementations, the VAE is a hierarchical VAE where each layer is a linear function of a plurality (e.g. all) previous layers. Each layer induces a nonlinearity, e.g. implicitly as a consequence of a sparse structure (such as by imposing the L1 prior), or by using a ReLU or other structure to provide nonlinearity. In some implementations, the output of the nonlinearity is linearly transformed to provide the parameters of a distribution describing an L1 prior for the next layer(s).

For example, the L1 prior can be provided by a Laplace distribution, with the mean and spread of the Laplace distribution being the outputs of the linear transformation of the nonlinearity's output. There are a number of forms that a Laplace distribution can take; one form that is parametrized to use a form similar to a Gaussian (but with an L1 norm) may be provided by:

$${p}_{ℒ ( μ , σ )} ( x ) = \frac{1}{2 {σ}^{2}} {e}^{- \frac{\vert x - μ \vert}{{σ}^{2}}}$$

The prior and approximating posterior distributions over corresponding to such a distribution can respectively be provided by:

pₛ(ζ|s)= [symbol] (μₚ,s·σₚ²)

qₛ(ζ|s,x)= [symbol] (s·μ_{q}+(1−s)·μₚ,s·σ_{q}²)

which may correspond to a KL term based on the following form:

$$KL ( {q}_{s} \vert \vert {p}_{s} ) = s \cdot \frac{\vert {μ}_{q} - {μ}_{p} \vert}{{σ}_{p}^{2}} .$$

Other forms of L1 prior may alternatively, or additionally, be used. These include, for example, a conventional Laplace distribution, defined by

$${p}_{ℒ ( μ , σ )} ( x ) = \frac{1}{2 σ} {e}^{- \frac{\vert x - μ \vert}{σ}} ,$$

or any other suitable distribution providing an L1 norm.

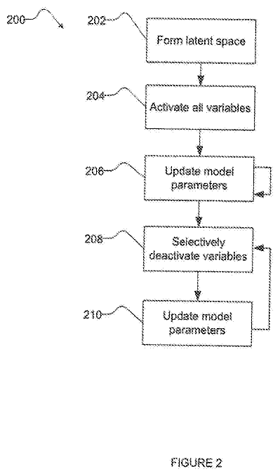

FIG. 2 is a flowchart of an example method 200 for training a VAE with selectively-activatable continuous latent variables based on a set of binary latent variables as described above. At 202, a computing system forms a latent space. At 204, during at least the early phases of training, all of the selectively-activatable continuous latent variables are activated (e.g., by setting all of their corresponding binary latent variables to their “on” states). At 206, the model parameters are updated, e.g., by computing the objective function over a training dataset, based on all of the selectively-activatable continuous latent variables being activated. This operation may occur any number of times. At 208, one or more selectively-activatable continuous latent variables are deactivated, e.g., by setting their corresponding binary latent variables to their “off” states. This deactivating may be repeated for individual input elements of the training dataset so that different input elements correspond to different sets of active/deactivated variables. At 210, the model parameters are updated, e.g., by computing the objective function over a training dataset, based on the subset of the selectively-activatable continuous latent variables which are activated (i.e., the deactivated selectively-activatable continuous latent variables do not contribute to the objective function, at least in respect of a particular input data element). Acts 208 and 210 may be performed any number of times.

### Rectifying VAEs

In some implementations, the approximating posterior distribution is truncated (e.g. via rectification) to activate or deactivate continuous latent variables of a VAE. The prior distribution may correspondingly be based on a truncated distribution, and may activate or deactivate the continuous latent variables based on, for example, a trained activation network (such as an RBM) conditioned on the latent space. This activation/deactivation can assist in providing greater sparsity.

For example, in a VAE having a set of continuous latent variables ζ, the approximating posterior over conditioned on x (i.e. q(ζ|x)) may be rectified such that q(ζᵢ|x) is a truncated distribution (e.g. a truncated Gaussian distribution) for each ζᵢ. This may be achieved by, for example, rectifying the continuous latent variables directly and/or by truncating the distribution from which continuous latent variables are sampled based on a discrete latent variable (e.g. where the VAE is a DVAE with discrete latent continuous variables).

In the former case, continuous random variables may be determined in the encoder of the VAE by the approximating posterior by using input data x to generate parameters (e.g. the mean μ and standard deviation a of a Gaussian distribution) characterizing a base distribution (e.g. [symbol] (μ, σ)) for one, some, or all of the continuous random variables ζ; sampling a given ζᵢ; and rectifying the sampled value. One example of rectification is applying a rectified linear unit (ReLU) to the continuous random variable ζᵢ, so that ζᵢ is mapped to 0 if its value is negative and left unchanged otherwise.

In the latter case, the encoder may train a set of random latent variables z (e.g. discrete random latent variables) to control the activation states of the continuous latent variables ζ and use those latent variables z to select the distribution from which the continuous random variables are sampled from. For example, if each continuous random variable ζᵢ has a corresponding discrete random variable zᵢ then the approximating posterior may be defined by:

q(ζᵢ|zᵢ==0)=δ(ζᵢ)

q(ζᵢ|zᵢ==1)=g(ζᵢ|x,θ))

where g is a distribution over the continuous latent variable(s) based on the parameters θ of the VAE and the input data x (to reduce clutter, the conditional x term is omitted in most equations herein). For instance, g could be a Gaussian distribution, which may optionally be truncated. Truncating g at 0 will yield a distribution similar to that of the rectification approach described above.

It is noted that such z-activated constructions are likely to be harder to train in the approximating posterior in some circumstances due to the form of the inverse CDF of q(ζᵢ|zᵢ). This is less of a concern for the prior distribution, for which it is not generally necessary to determine the inverse CDF but which does not necessarily have the opportunity to be conditioned on the input data. The prior distribution may be constructed in any suitable way, usually so as to correspond generally in structure to the approximating posterior.

Note that the term “prior distribution” is used in several contexts, including the general form p(x, ζ) (or p(x,ζ,z) for implementations with discrete variables) and in the more computationally-relevant marginalizations and conditionalizations p(ζ) p(ζ|z), and p(x|ζ) The last of these is sometimes called the “decoding distribution”. In at least some implementations the decoding distribution can be implemented in any suitable way without necessarily requiring further modification, allowing the present disclosure to focus more closely on aspects of the prior distribution defined over the latent space such as p(z), p(ζ) and p(ζ|z).

In at least some implementations, the approximating posterior distribution involves sampling the continuous random variable from its base distribution and rectifying the sampled value and the prior distribution involves controlling activation of continuous latent variables ζ based on discrete latent variables z thus mixing the two above-described approaches within a VAE.

For example, in a DVAE having a set of binary latent variables z and an associated set of continuous latent variables ζ, the approximating posterior over each (z,ζ) pair of corresponding binary and continuous latent variables may be defined so that the conditional distribution over the continuous latent variable ζ is a truncated Gaussian distribution when z=1. The DVAE's encoder may be structured as usual (e.g. as described elsewhere herein or in the herein-cited works), except that a rectified linear unit (ReLU) is applied to each sample of the continuous latent variables ζ. The binary latent variables z of the DVAE may control the behavior of the ReLU, e.g. such that one state of a binary latent variable z induces the linear regime and the other state corresponds to the rectifying regime.

In some implementations having discrete latent variables z, the prior of binary latent variables z may be an RBM, e.g. as characterized by:

$$p ( z ) = \frac{1}{{𝒵}_{p}} {e}^{- {E}_{p} ( z )} = \frac{1}{𝒵} {e}^{{z}^{T} Wz + {b}^{T} z}$$

and/or a sigmoid belief network, e.g. as characterized by:

p(zᵢ=1|z_{j<i})=(1+e^{-ƒ(z}^{_{j<i}}⁾)⁻¹

where ƒ(x) is a trainable quantity, such as (for example) a neural network with a scalar output.

The prior of the continuous latent variables ζ may be conditioned on the binary latent variables z by setting the prior of a continuous latent variable ζᵢ to correspond to a Dirac delta distribution when a corresponding binary latent variable zᵢ is in the inactive state (e.g. zᵢ=0) and to a Gaussian truncated at zero when zᵢ is in the active state (e.g. zᵢ=1).

The parameters for the truncated Gaussian distribution (e.g. the mean(s) and standard deviation(s) of the Gaussian distributions on which the truncated Gaussian distributions are based) for the various continuous latent variables may be determined via training. For example, they may be learned by a neural network or other trainable quantity. In some implementations, the neural network used for each ζᵢ receives all ζ_{j<i} as input. Optionally, it may receive all binary latent variables z or a subset thereof (e.g. z_{j<i} and/or z_{j≤i}) as input. In some implementations, the approximating posterior specifies distributions over a plurality of related latent variables, e.g. by determined the specified distributions based on one (shared) Gaussian distribution.

For example, the prior for a continuous latent variable ζᵢ may be determined conditionally on a corresponding binary latent variable zᵢ according to the following formulae:

$$p ( {ζ}_{i} \vert {z}_{i} = 0 ) = δ ( ζ )$$

$$p ( {ζ}_{i} \vert {z}_{i} = 1 ) = {( {\int }_{x = 0}^{∞} {p}_{𝒩 ( μ , {σ}^{2} )} ( x ) )}^{- 1} {p}_{𝒩 ( μ , {σ}^{2} )} ( {ζ}_{i} ) [ {ζ}_{i} \geq 0 ] = \frac{2}{1 + erf \frac{μ}{σ \sqrt{2}}} \frac{1}{\sqrt{2 π {σ}^{2}}} {e}^{- \frac{{( {ζ}_{i} - μ )}^{2}}{2 {σ}^{2}}}$$

where μ is a trainable mean shared between a plurality (e.g. all, or a subset of related) active continuous latent variables and a is a trainable standard deviation shared between all active continuous latent variables. These may be implemented as a neural network or via any other suitable technique. For example, they may be determined as follows:

μ=ƒ(ζ_{j<i})

log σ=g(ζ_{j<i})

where ƒ and g are neural networks or another trainable quantity.

In some implementations, continuous latent variables are divided into a set of N disjoint groups. For example, in the RBM-based prior for binary latent variables provided above, one may set Wᵢⱼ=c>0 if the ζᵢ and ζⱼ corresponding to zᵢ and zⱼ respectively are in the same group, Wᵢⱼ=−c otherwise, and bᵢ=c for all i.

This approach is not limited to DVAEs. In some implementations, the truncation/rectification of one or more distributions associated with the continuous latent variables is performed by providing a binary inactivation decision and an identity activation function (without necessarily providing an explicit binary latent variable). For example, a VAE may apply a ReLU to its continuous latent variables ζ such that the approximating posterior is sampled from the process given by ζ˜ReLU( [symbol] (μ, σ²), where ReLU(x)=x if x>0 and ReLU(x)=0 otherwise. (We can express this using Iverson brackets as ReLU(x)=x·[x<0].) This corresponds to following distribution:

$$q ( ζ ) = \{ \begin{matrix}0 & if ζ < 0 \\ δ ( 0 ) \cdot {\int }_{x = - ∞}^{0} {p}_{𝒩 ( μ , {σ}^{2} )} ( x ) & if ζ = 0 \\ {p}_{𝒩 ( μ , {σ}^{2} )} ( x ) & if ζ > 0\end{matrix}$$

This distribution is challenging to sample from, but it can be reformulated to sample from a Bernoulli random variable to determine whether a sample is in the zero regime first, and then conditionally sampling from the continuous value. Put more generally, if we consider the binary inactivation decision of an input x (e.g. by a ReLU or otherwise) to be z=[x>0], then the above construction of the distribution corresponds to the construction p(x,z)=p(x)·p(z|x). We can reformulate this to p(x,z)=p(z) p(x|z). In the case of the above example, this yields the following construction of the approximating posterior:

$$q ( z = 0 ) = {\int }_{x = - ∞}^{0} {p}_{𝒩 ( μ , {σ}^{2} )} ( x ) = \frac{1}{2} \cdot ( 1 + erf ( - \frac{μ}{σ \sqrt{2}} ) )$$

$$q ( z = 1 ) = 1 - q ( z = 0 ) = {\int }_{x = 0}^{∞} {p}_{𝒩 ( μ , {σ}^{2} )} ( x ) = \frac{1}{2} \cdot ( 1 + erf ( \frac{μ}{σ \sqrt{2}} ) )$$

$$q ( ζ \vert z = 0 ) = δ ( ζ )$$

$$q ( ζ \vert z = 1 ) = {( {\int }_{x = 0}^{∞} {p}_{𝒩 ( μ , {σ}^{2} )} ( x ) )}^{- 1} \cdot {p}_{𝒩 ( μ , {σ}^{2} )} ( ζ ) \cdot [ ζ \geq 0 ] = \frac{2}{1 + erf ( \frac{μ}{σ \sqrt{2}} )} \cdot \frac{1}{\sqrt{2 π {σ}^{2}}} \cdot {e}^{\frac{- {( ζ - σ )}^{2}}{2 {σ}^{2}}}$$

where μ and σ are trainable quantities as described above and δ(x) is the Dirac delta function centered at x. Samples of ζ can be drawn as described above and the binary inactivation decision z (which may or may not correspond to an explicit variable of the VAE's latent space) may be determined based on z=[ζ≥0]. This formulation is compatible with the reparametrization trick when z is marginalized out. The approximating posterior and prior distributions may be constructed so that p(ζᵢ|zᵢ=0)=q(ζᵢ|zᵢ=0) and KL(ζᵢ|zᵢ)=0 if zᵢ=0. Any inactive continuous variables will thus not contribute to the KL-term and can be ignored for at least that portion of each training cycle.

In implementations where a ReLU is applied to a continuous latent variable in the VAE's decoder without mediation by binary latent variables, the KL-term is likely to be non-zero even when ReLU(ζ)=0. The KL term can be driven towards 0 by causing the approximating posterior and prior distributions to approach equality for inactive continuous latent variables. In some implementations, the approximating posterior is defined hierarchically. The KL term may also be defined hierarchically, e.g. as follows:

$$KL = {\sum }_{hierarchy} KL = {\sum }_{hierarchy} KL ( z ) + KL ( ζ \vert z ) .$$

In some implementations, such as some hierarchical implementations and also some implementations with an RBM-structured prior (whether or not hierarchical), the gradients of the KL-term of the ELBO (provided above) are estimated stochastically (e.g. as described by Rolfe, Discrete Variational Autoencoder, arXiv preprint arXiv:1609.02200 (2016), incorporated herein by reference). In some such implementations, the KL-term's gradients may be determined over model parameters θ and ϕ based on:

$$\frac{\partial }{\partial θ} KL [ q \vert \vert p ] = {𝔼}_{q ( {z}_{1} \vert x , φ )} [ … [ {𝔼}_{q ( {z}_{k} \vert {ζ}_{i < k} , x , φ )} [ \frac{\partial {E}_{p} ( z , θ )}{\partial θ} ] ] ] - {𝔼}_{p ( z \vert θ )} [ \frac{\partial {E}_{p} ( z , θ )}{\partial θ} ] , \\ \frac{\partial }{\partial φ} KL [ q \vert \vert p ] = {𝔼}_{ρ} [ {( g ( x , ζ ) - b )}^{T} \cdot \frac{\partial q}{\partial φ} - {z}^{T} \cdot W \cdot ( \frac{1 - z}{1 - q} ⊙ \frac{\partial q}{\partial φ} ) ] .$$

Note that these quantities may be determined via other approaches. The example approach to determining the gradient over ϕ will tend to have lower variance than certain nave, REINFORCE-based approaches.

In some implementations, unused or inactive latent variables are subject to regularization in the KL term to draw them towards zero. For example, such variables may be subject to a (weak) L1 or L2 regularization.

Once the prior distribution defined over the latent space has generated suitable ζ values, the decoding distribution (which, as noted above, may also be considered to be part of the prior distribution over the model) may generate values in the input space via any suitable methods now known or later discovered.

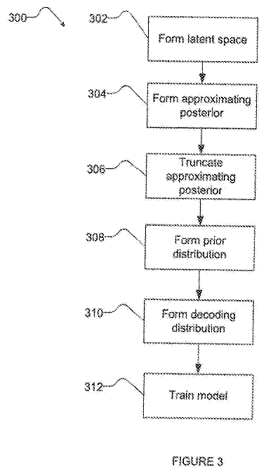

FIG. 3 is a flowchart of an example method 300 for training a VAE with an approximating posterior distribution based on a truncated distribution as described above. At 302, a computing system forms a latent space having continuous latent variables. In some implementations the latent space also has discrete latent variables (e.g. in DVAE-based implementations, as described above).

At 304, the computing system forms an approximating posterior distribution and, at 306, the computing system truncates the approximating posterior distribution. Acts 304 and 306 may be performed together and are shown separately for emphasis. These acts may be performed in any of a variety of ways, as described herein, including by rectifying continuous latent variables directly and/or by activating distributions defined over the continuous latent variables based on discrete latent variables.

At 308, the computing system forms a prior distribution over the latent space (e.g. p(ζ), p(ζ|z), and/or p(z)). The prior distribution may comprise an RBM over discrete latent variables. The prior distribution may select the activation regime (e.g. activated/inactivated) of the continuous latent variables based on the discrete random variables. The prior distribution may provide distributions for continuous latent variables ζ which corresponds in form to those of the approximating posterior; for example, if the approximating posterior distribution uses truncated Gaussian distributions, the prior distribution may also use truncated Gaussian distributions (which may be separately parametrized for a given ζ) in the activated regime.

At 310, the computing system forms the decoding distribution, as described above or by other suitable methods. At 312, the computing system trains the model based on the formed distributions and the latent space.

### Concluding Generalities

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the exemplary methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to:

PCT patent application no. US2016/047627;

U.S. patent application Ser. No. 15/725,600;

U.S. provisional patent application No. 62/598,880;

U.S. provisional patent application No. 62/637,268; and

U.S. provisional patent application No. 62/731,694.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method for unsupervised learning over an input space comprising a plurality of input variables, and at least a subset of a training dataset of samples of the respective variables, to attempt to identify the value of at least one parameter that increases the log-likelihood of the at least a subset of a training dataset with respect to a model, the model expressible as a function of the at least one parameter, the method executed by circuitry including at least one processor and comprising;
forming a latent space comprising a plurality of continuous random latent variables;
forming an approximating posterior distribution over the latent space, conditioned on the input space, and formed by, for each of the continuous random latent variables, truncating a corresponding encoding base distribution based on input data from the input space;
forming a prior distribution over the latent space;
forming a decoding distribution over the input space; and
training the model based on the encoding, prior, and decoding distributions.

2. The method of claim 1 wherein forming the prior distribution comprises, for each of the continuous random latent variables, truncating a corresponding prior base distribution by rectifying the corresponding prior base distribution based on the continuous random latent variable.

3. The method of claim 2 wherein, for each continuous random latent variable, the corresponding encoding base distribution and the corresponding prior base distribution are parametrizations of a shared distribution, forming the prior distribution comprises truncating the shared distribution, and forming the approximating posterior distribution comprises truncating the shared distribution.

4. The method of claim 3 wherein the shared distribution comprises a Gaussian distribution and truncating the shared distribution comprises truncating the Gaussian distribution.

5. The method of claim 1 wherein, when forming the approximating posterior, truncating the corresponding encoding base distribution comprises rectifying at least one of the continuous random latent variables.

6. The method of claim 5 wherein training the model comprises determining a gradient over the approximating posterior based on a reparametrization of the at least one of the continuous random latent variables.

7. The method of claim 5 wherein rectifying at least one of the continuous random latent variables comprises applying a rectified linear unit to an initial value of the at least one of the continuous random latent variables generated by the approximating posterior distribution.

8. The method of claim 1 wherein forming the latent space further comprises forming a plurality of discrete random latent variables and, for each of the plurality of continuous variables, truncating the corresponding prior base distribution comprises truncating the corresponding prior base distribution based on a state of a corresponding one of the discrete random latent variables.

9. The method of claim 8 wherein, for each of the plurality of continuous variables, truncating the corresponding prior base distribution based on the state of the corresponding one of the discrete random latent variables comprises selecting at least one of: an activation regime and an inactivation regime and:
if the activation regime is selected, causing samples to be drawn for the continuous random variable from the corresponding prior base distribution; and
if the inactivation regime is selected, causing samples to be drawn for the continuous random variable from a singularity distribution.

10. The method of claim 9 wherein the singularity distribution comprises a Dirac delta distribution.

11. The method of claim 9 wherein training the model comprises regularizing one or more continuous random latent variables based on the one or more continuous random latent variables being in the activation regime.

12. The method of claim 1 wherein each of a first subset of the plurality of continuous random latent variables share a first common base distribution and forming the approximating posterior distribution comprises, for each of the first subset, truncating a corresponding approximating posterior base distribution comprises truncating the first common base distribution.

13. The method of claim 12 wherein training the model comprises determining a gradient of an objective function based on a reparametrization of the first subset of continuous random latent variables.

14. The method of claim 13 wherein:
each of a second subset of the plurality of continuous random latent variables share a second common base distribution, the second common base distribution having at least one trainable parameter separate from the one or more trainable parameters of the first common base distribution; and
forming the approximating posterior distribution comprises, for each continuous random latent variable of the second subset, truncating a corresponding approximating posterior base distribution comprises truncating the first common base distribution.

15.-26. (canceled)

27. A computational system, comprising:
at least one processor; and
at least one nontransitory processor-readable storage medium that stores at least one of processor-executable instructions or data which, when executed by the at least one processor cause the at least one processor to:
form a latent space comprising a plurality of continuous random latent variables;
form an approximating posterior distribution over the latent space, conditioned on the input space, and formed by, for each of the continuous random latent variables, truncating a corresponding encoding base distribution based on input data from the input space;
form a prior distribution over the latent space;
form a decoding distribution over the input space; and
train the model based on the encoding, prior, and decoding distributions.
